(19) United States
(12) Patent Application Publication
(10) Pub. No.: US 2017/0063725 A1
(43) Pub. Date: Mar. 2, 2017

(54) CONTROL METHOD, CONTROL DEVICE, AND STORAGE MEDIUM

(71) Applicant: FUJITSU LIMITED, Kawasaki-shi (JP)

(72) Inventors: Tomotaka ENDO, Yokohama (JP); Hideyuki Matsuda, Atsugi (JP)

(73) Assignee: FUJITSU LIMITED, Kawasaki-shi (JP)

(21) Appl. No.: 15/207,998

(22) Filed: Jul. 12, 2016

(30) Foreign Application Priority Data
Aug. 31, 2015 (JP) 2015-171241

(51) Int. Cl. H04L 12/947; H04L 12/931; H04L 12/721

(52) U.S. Cl. CPC H04L 49/25; H04L 45/66; H04L 49/206

(57) ABSTRACT

A control method executed by a control device includes detecting a notification to inform that switching of a line used for transferring packets by a first transfer device and a second transfer device is to be occurred; transmitting, to the first transfer device and the second transfer device, an instruction for requesting to transfer the packets to the control device; storing the packets received from the first transfer device and the second transfer device; transmitting, to the first transfer device and the second transfer device, a transfer rule for designating a line after the switching as an output destination of the packets to be transferred by the control device, when the switching occurred; reading the stored packets; and transmitting the read packets to the first transfer device and the second transfer device at a speed at which the read packets is transferable by using the line after the switching.

### CROSS-REFERENCE TO RELATED APPLICATION

This application is based upon and claims the benefit of priority of the prior Japanese Patent Application No. 2015-171241, filed on Aug. 31, 2015, the entire contents of which are incorporated herein by reference.

### FIELD

The embodiments discussed herein are related to a control method, a control device, and a storage medium.

### BACKGROUND

An owner who owns communication lines uses some lines as protection lines in preparation for the occurrence of a failure or the like, in some cases. In a case where a failure or the like does not occurs the owner performs communication by using lines that are different from the protection lines and that are included in the lines owned by the owner. In this case, the protection lines are used for communication of a user other than the owner.

FIG. 1 is a diagram for explaining an example of communication processing. A network N1 illustrates an example of communication processing before the occurrence of a failure. In the network N1, a switch 5a and a switch 5b are coupled to each other by using lines L1 to L3, and no failure occurs in each of the lines L1 to L3. Each of the lines L1 to L3 may be routed through a switch other than the switch 5a and the switch 5b or a communication device such as a router. However, in FIG. 1, these are omitted in order to simplify the drawing. Both the switch 5a and the switch 5b are coupled to a monitoring device 3.

In a state illustrated in the network N1, a user A owns the line L1 and the line L2, and a user N owns the line L3. The line L1 contains communication of the user A. The line L2 is a protection line for communication of the user A. Since the user A owns the line, the type (service level agreement (SLA)) of communication of the user A is set to a guarantee type. In a guarantee type communication service, control is performed so that a communication speed or a communication quality becomes greater than or equal to a preliminarily set setting value. The line L2 is not used for the communication of the user A until a failure occurs in the line L1. Therefore, the line L2 contains communication of a user B who uses a best-effort (BE) type service. The line L3 is not used for communication of the user N and contains communication of a user C, a user D, and a user E who each perform best-effort type communication. Furthermore, even if containing the communication of the users C to E, the line L3 is further available for other communication. “X” illustrated in the line L3 in the network N1 is an example of a capacity available, in the line L3, for communication other than the communication contained in the line L3.

A network N2 illustrates an example of communication processing in a case where a failure occurs in the line L1. In the network N2, in association with the occurrence of the failure in the line L1, the communication of the user A is relayed via the line L2. In a case of being used for the communication of the user A, the line L2 does not a capacity sufficient to contain the communication of the user B. In this case, a transfer path of packets used for the communication of the user B is switched from a path utilizing the line L2 to a path utilizing the free capacity X in the line L3. In this regard, however, if a communication speed obtained by using the free capacity X in the line L3 is lower than a communication speed in a case where the communication of the user B is contained in the line L2, a communication speed available for the user B is reduced by switching a line used for the communication of the user B.

As a related technique, there is devised a system in which packets, which are difficult to subject to routing and which are included in packets from a user device, are temporarily accumulated by a buffer coupled to a packet exchange switch (for example, Japanese Laid-open Patent Publication No. 5-37561 or the like). There is proposed a method for updating information, in which conditions of detecting packets in individual interfaces and contents of transfer control applied to detected packets are associated with one another, if a relay device including the interfaces detects a change in a path state (for example, Japanese Laid-open Patent Publication No. 2014-158084 or the like). There is proposed a method for dynamically determining, at the time of the occurrence of a failure or at the time of a recovery from a failure, a transmission path to be used as a backup system, by using the quality and the priority of a transmission path at that point in time (for example, Japanese Laid-open Patent Publication No. 2001-339370 or the like).

Depending on timing between switching of a line to contain communication of a user and outputting of packets from a device such as a switch, a packet loss occurs in some cases. However, if any one of the techniques described as the related art is applied, it is difficult to avoid a packet loss associated with switching of a line. In, for example, the system in which packets difficult to subject to routing are temporarily accumulated by the buffer, packets of communication in which a line is changed is able to be subjected to routing. Therefore, the packets are not subjected to buffering and cause a packet loss.

### SUMMARY

According to an aspect of the invention, a control method executed by a processor included in a control device coupled to a first transfer device and a second transfer device, the first transfer device being coupled to the second transfer device via a plurality of lines, the control method includes detecting a notification to inform that switching of a line used for transferring packets by the first transfer device and the second transfer device, among the plurality of lines, is to be occurred; transmitting, to the first transfer device and the second transfer device, an instruction for requesting to transfer the packets to the control device; storing the packets received from the first transfer device and the second transfer device; transmitting, to the first transfer device and the second transfer device, a transfer rule for designating a line after the switching, among the plurality of lines, as an output destination of the packets to be transferred by the control device, when the switching occurred; reading the stored packets; and transmitting the read packets to the first transfer device and the second transfer device at a speed at which the read packets are transferable by using the line after the switching.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an example of communication processing;

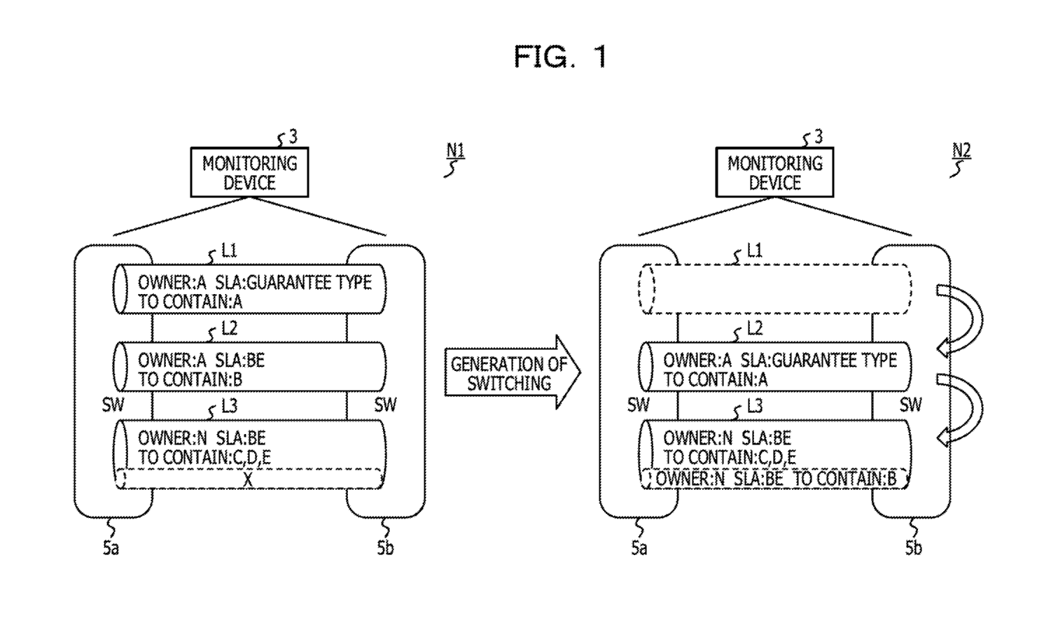

FIG. 2 is a diagram for explaining an example of a communication system according to an embodiment;

FIG. 3 is a flowchart for explaining an example of communication processing according to an embodiment;

FIG. 4 is a diagram for explaining an example of a configuration of a control device;

FIG. 5 is a diagram for explaining an example of a hardware configuration of a control device;

FIG. 6 is a diagram illustrating an example of a communication state before the generation of switching;

FIG. 7 is a diagram for explaining an example of a setting information table;

FIG. 8 is a diagram for explaining an example of a flow information table;

FIG. 9 is a diagram for explaining an example of a line information table;

FIG. 10 is a diagram for explaining an example of a flow table;

FIG. 11 is a diagram illustrating an example of a communication state at the time of the generation of switching;

FIG. 12 is a diagram for explaining an example of the line information table;

FIG. 13 is a diagram for explaining an example of the line information table;

FIG. 14 is a diagram for explaining an example of a flow table;

FIG. 15 is a flowchart for explaining an example of processing for switching a line;

FIG. 16 is a diagram illustrating an example of communication after switching of a line;

FIG. 17 a flowchart for explaining an example of processing of packets after a line is switched; and

FIG. 18 is a sequence diagram for explaining an example of communication processing.

### DESCRIPTION OF EMBODIMENTS

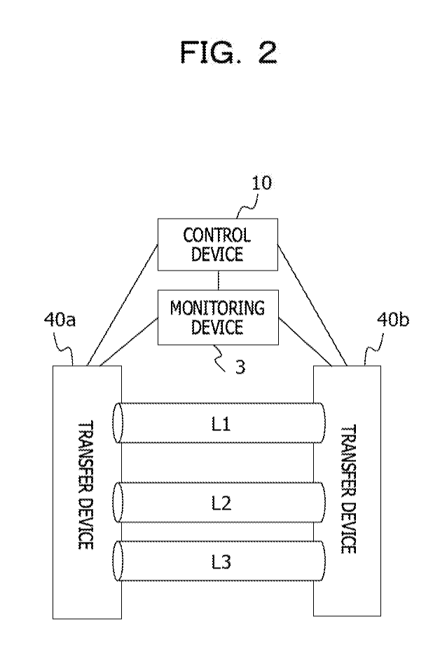

FIG. 2 is a diagram for explaining an example of a communication system according to an embodiment. In the communication system according to an embodiment, lines L1 to L3 couple a transfer device 40a and a transfer device 40b to each other. Furthermore, each of the transfer device 40a and the transfer device 40b is able to communicate with a control device 10 in addition to a monitoring device 3. In accordance with a transfer rule given notice of by the control device 10, each of the transfer devices 40 performs transfer processing of packets. In a case of failing in processing packets by using the transfer rule or in a case of storing no transfer rule for packets serving as processing targets, each of the transfer devices 40 notifies the control device 10 of information of the packets serving as processing targets and requests a transfer rule applicable to the packets serving as processing targets. The monitoring device 3 monitors communication contained in the lines L1 to L3 and states of the respective lines L1 to L3. The control device 10 communicates with the monitoring device 3.

In a case where switching of a line is generated, the monitoring device 3 notifies the control device 10 of the generation of switching of a line. Then, since a packet loss is liable to occur at the time of switching of a line, the control device 10 requests each of the transfer device 40a and the transfer device 40b to transmit, to the control device 10, packets for which a line used for transfer is changed. In response to the request from the control device 10, the transfer device 40a and the transfer device 40b each transfer, to the control device 10, packets to be transmitted by using a line to serve as a target of switching processing.

The control device 10 buffers packets received from the transfer device 40a and the transfer device 40b. If the switching processing finishes, the control device 10 transmits, to each of the transfer device 40a and the transfer device 40b, a transfer rule for designating a line after switching, as an output destination of packets transferred by the control device 10. After that, the control device 10 outputs the buffered packets to the transfer device 40a and the transfer device 40b. In accordance with the transfer rule, each of the transfer device 40a and the transfer device 40b outputs, to a line after switching, packets acquired from the control device 10.

In this way, in a method according to an embodiment, packets are buffered by the control device 10 at the time of switching of a line. Therefore, it is possible to avoid a packet loss associated with the switching of a line.

In the method according to an embodiment, it is possible to avoid a packet loss that may occur in a case where the communication speed of a user is reduced in association with switching of a line. A line to contain communication of a user who uses, for example, a best-effort type service is switched, and accordingly, the communication speed of the user becomes slower than that before the switching of the line, in some cases. In a case where a communication speed is reduced owing to switching of a line, a transmission source of packets does not recognize that a communication speed is changed in association with the switching of a line. Therefore, transmission packets are transmitted in the same way as before the switching of a line. Accordingly, in a case where the line used for the communication of the user who uses the best-effort type service is changed, if the method according to an embodiment is not used, a packet loss is highly likely to occur. However, in the method according to an embodiment, packets used for communication of a user, in which a communication speed is reduced owing to switching of a line, are able to be buffered by the control device 10. Therefore, it is possible to avoid a packet loss.

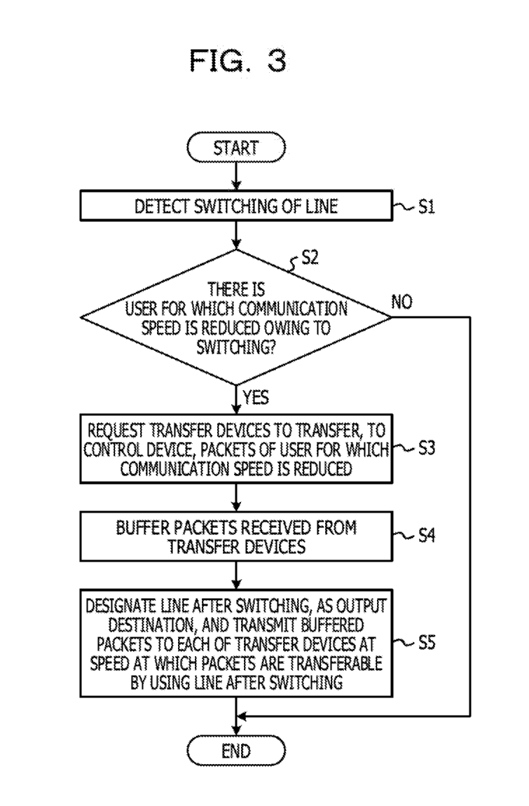

FIG. 3 is a flowchart for explaining an example of communication processing according to an embodiment. In a method according to FIG. 3, processing for more efficiently avoiding a packet loss associated with the reduction of a communication speed of a user at the time of changing a line is added to the method described in FIG. 2.

Based on communication with the monitoring device 3, the control device 10 detects that a line used for communication of a user is switched (S1). For each of uses serving as targets of the switching of the line, by using a result of comparing a current communication speed and a prediction value of a communication speed obtained after switching with each other, the control device 10 determines that there is a user for which a communication speed is reduced owing to the switching (S2). In a case where there is no user for which a communication speed is reduced owing to the switching, the control device 10 terminates the processing (S2: No).

On the other hand, in a case where there is a user for which a communication speed is reduced owing to the switching, the control device 10 requests the transfer device 40a and the transfer device 40b to transfer, to the control device 10, packets used for communication of the user for which a communication speed is reduced (S2: Yes, S3). The control device 10 buffers packets received from the transfer device 40a and the transfer device 40b (S4). After that, the control device 10 transmits buffered packets to each of the transfer devices 40 at a speed at which the packets are transferable by using a line after the switching (S5). In S5, the control device 10 notifies each of the transfer devices 40, which serves as a transfer destination of buffered packets, of information for designating, as an output destination, a line after switching, as the transfer rule.

In this way, in the method illustrated in FIG. 3, upon identifying communication of a user for which a communication speed is reduced owing to switching of a line, the control device 10 requests each of the transfer devices 40 to change, to the control device 10, a transfer destination of packets used for the communication of the user for which a communication speed is reduced. Furthermore, by buffering packets transferred by each of the transfer devices 40, the control device 10 adjusts a transfer speed of buffered packets in accordance with a communication speed after switching of a line. Therefore, it is possible for the control device 10 to avoid the occurrence of a packet loss in each of the transfer devices 40, caused by the reduction of a communication speed.

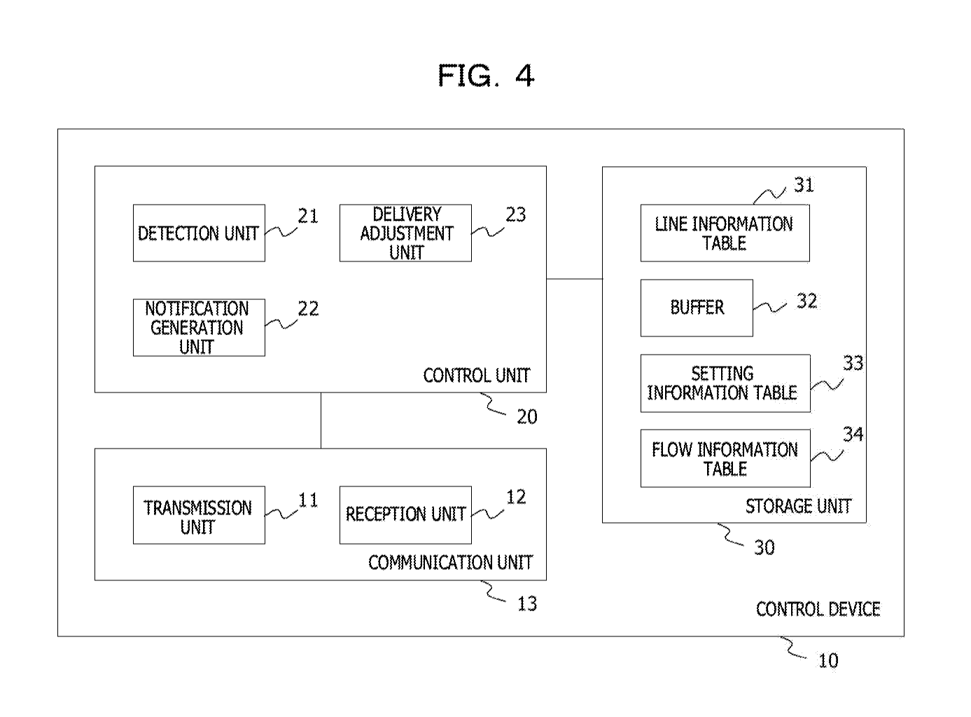

FIG. 4 is a diagram for explaining an example of a configuration of the control device 10. The control device 10 includes a communication unit 13, a control unit 20, and a storage unit 30. The communication unit 13 includes a transmission unit 11 and a reception unit 12. The control unit 20 includes a detection unit 21, a notification generation unit 22, and a delivery adjustment unit 23. The storage unit 30 stores therein a line information table 31, a setting information table 33, and a flow information table 34 and operates as a buffer 32.

The transmission unit 11 transmits packets to another device. The reception unit 12 receives packets from another device. Based on communication with the monitoring device 3, the detection unit 21 detects switching of a line. By arbitrarily using information of the line information table 31 or the setting information table 33, the detection unit 21 detects communication in which a communication speed is reduced owing to switching of a line. The notification generation unit 22 generates a control packet for requesting each of the transfer devices 40 to transfer, to the control device 10, packets of a user for which a communication speed is reduced. The control packet is transmitted to each of the transfer devices 40 via the transmission unit 11. Packets transferred by the transfer devices 40 that each receives the control packet are buffered by the buffer 32. The delivery adjustment unit 23 transmits, to each of the transfer devices 40, packets buffered by the buffer 32, at a speed at which the packets are transferable by using a line after the switching. For each of lines used for communication, the setting information table 33 records therein information of a holder, an upper limit of a communication speed obtained by the relevant line, and so forth. The flow information table 34 stores therein information of flows transmitted and received by the transfer devices 40 serving as control targets of the control device 10. Specific examples of the line information table 31, the setting information table 33, and the flow information table 34 will be described later.

The control device 10 may be realized by, for example, a computer. The control device 10 operates as a controller of, for example, a software-defined network (SDN). On the other hand, the transfer devices 40 each operate as a switch in the SDN.

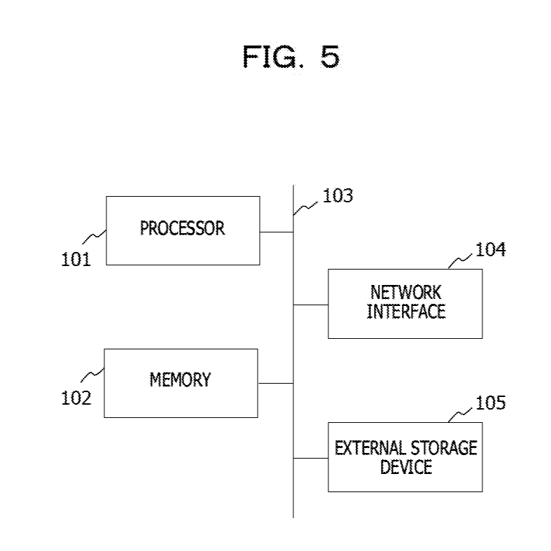

FIG. 5 is a diagram for explaining an example of a hardware configuration of the control device 10. The control device 10 includes a processor 101, a memory 102, a bus 103, a network interface 104, and an external storage device 105. The processor 101 is an arbitrary processing circuit including, for example, a central processing unit (CPU). By using the memory 102 as a working memory, the processor 101 executes a program, thereby performing various processing operations. The memory 102 includes a random access memory (RAM) and further includes a non-volatile memory such as a read only memory (ROM). The memory 102 or the external storage device 105 is used for storing a program and data used for processing in the processor 101. The bus 103 couples the processor 101, the memory 102, the network interface 104, and the external storage device 105 to one another so that the processor 101, the memory 102, the network interface 104, and the external storage device 105 are able to input and output data from and to one another. In the control device 10, the processor 101 operates as the control unit 20, and the memory 102 and the external storage device 105 operate as the storage unit 30. Furthermore, the network interface 104 realizes the communication unit 13.

Hereinafter, communication processing performed in a system according to an embodiment will be described by dividing into a communication state before the generation of switching of a line, processing performed at the time of the switching of a line, and communication after the switching of a line.

(1) Communication State before Generation of Switching

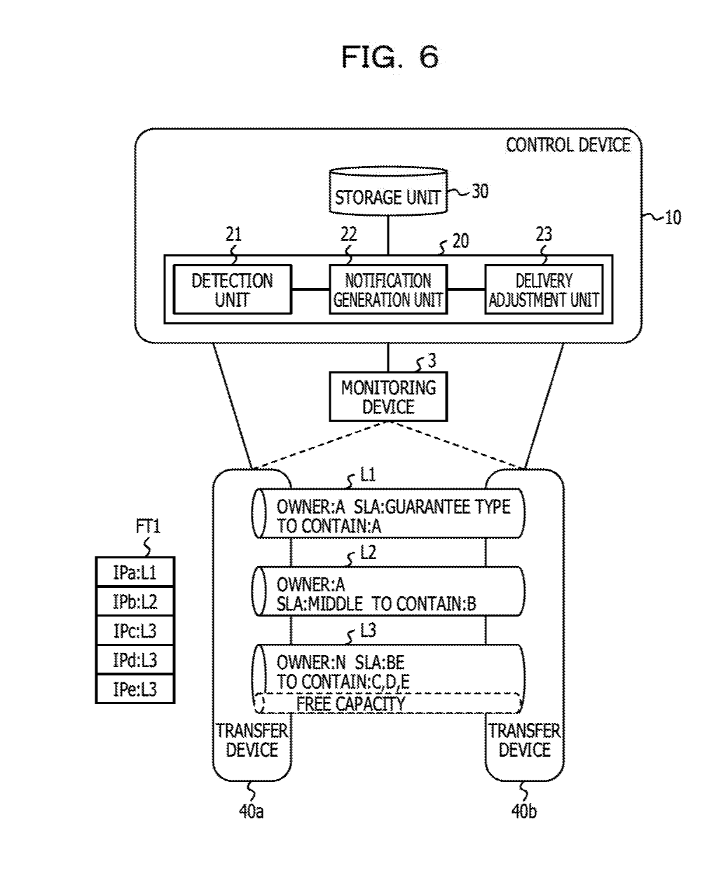

FIG. 6 is a diagram illustrating an example of a communication state before the generation of switching. In the state of FIG. 6, the transfer device 40a and the transfer device 40b are coupled to each other by the lines L1 to L3. Furthermore, each of the transfer device 40a and the transfer device 40b is coupled to the monitoring device 3 and the control device 10. In the example of FIG. 6, the user A owns the line L1 and the line L2, and the user N owns the line L3. The line L2 is secured as a protection line for the user A.

In the system according to an embodiment, at the time of making a contract, each of users selects one of a guarantee type, a best-effort type, and a middle type, as quality (SLA) of communication performed by the relevant user. In a guarantee type communication service, a communication speed or a communication quality is controlled so as to become greater than or equal to a preliminarily set setting value. In the best-effort type, after securing the communication quality of a user who makes a guarantee type contract, communication utilizing an available line is performed. Therefore, depending on the availability of s communication line, a delay or a packet loss may occur. In the middle type, after securing the communication quality of a user who makes a guarantee type contract, communication utilizing an available line is performed. However, in, for example, a case where line allocation is changed, control is performed so as to avoid the occurrence of a packet loss. In the following description, the user A makes a guarantee type communication contract, the user B makes a middle type communication contract, and the users C to E make best-effort type communication contracts with a carrier.

The monitoring device 3 holds contract details of lines and contract details of users and arbitrarily uses these at the time of determining communication to be contained in each of the lines. As a method for determining communication to be contained in each of the lines, an arbitrary known method is used. In the example of FIG. 6, the communication of the user A is contained in the line L1, the communication of the user B is contained in the line L2, and the communication of the users C to E is contained in the line L3. In the line L3, a free capacity for containing communication of a user other than the users C to E remains.

Since performing communication by using a transfer rule given notice of by the control device 10, each of the transfer device 40a and the transfer device 40b holds a flow table in which the transfer rule is recorded. The transfer device 40a holds, for example, a flow table FT1. In the flow table FT1, a transmission source address of a packet processed by the transfer device 40a and an identifier of a line used for communication are associated with each other. In FIG. 6, as addresses, “IPa”, “IPb”, “IPc”, “IPd”, and “IPe” are assigned to a terminal of the user A, a terminal of the user B, a terminal of the user C, a terminal of the user D, and a terminal of the user E, respectively. Therefore, the transfer device 40a outputs, to the line L1, a packet transmitted by the terminal of the user A and outputs, to the line L2, a packet transmitted by the terminal of the user B. Furthermore, each of the transfer devices 40 outputs, to the line L3, a packet transmitted by a terminal used by one of the users C to E.

Hereinafter, specific examples of pieces of information held by the control device 10 in a case where the communication illustrated in FIG. 6 is performed will be described with reference to FIGS. 6 to 9.

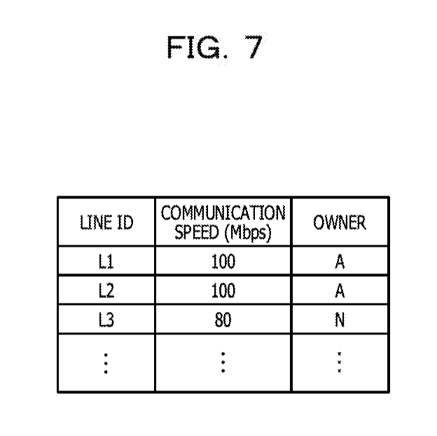

FIG. 7 is a diagram for explaining an example of the setting information table 33. In the network illustrated in FIG. 6, the control device 10 holds the setting information table 33 illustrated in FIG. 7. In the setting information table 33, for each of lines used in the network, pieces of information of a line ID, a communication speed, and an owner of a line are recorded. In the following description, an upper limit of a communication speed obtained by each of the line L1 and the line L2 is 100 Mbps, and an upper limit of a communication speed obtained by the line L3 is 80 Mbps. The setting information table 33 illustrated in FIG. 7 is an example and the information of, for example, an owner of a line does not have to be included in the setting information table 33.

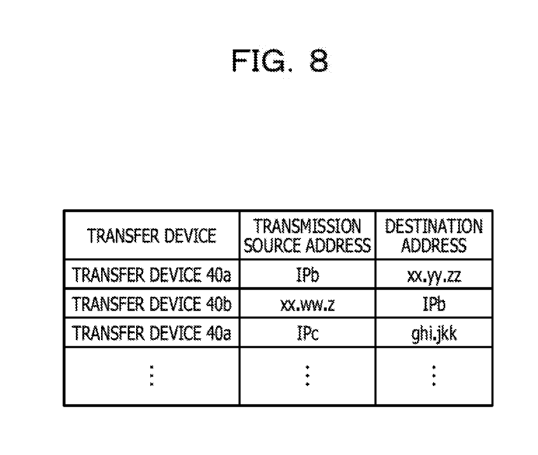

FIG. 8 is a diagram for explaining an example of the flow information table 34. In the example of FIG. 8, the flow information table 34 records therein a combination of a transmission source address and a destination address set in a packet transferred by each of the transfer devices 40 while associating the transmission source address and the destination address with the identifier of the relevant transfer device 40. Therefore, the control device 10 is able to recognize one of the transfer devices 40 and a flow whose packets are transferred by the relevant transfer device 40.

As described with reference to FIG. 6, in accordance with the flow table in which the transfer rule given notice of by the control device 10 is recorded, each of the transfer devices 40 in the network processes received packets. Therefore, each of the transfer devices 40 inquires of the control device 10 about processing of packets for which no transfer rule is acquired. For this inquiry, for example, a Packet-In message including at least some of packets for which processing is inquired about is used. As the transfer rule, the notification generation unit 22 in the control device 10 gives notice of a content of processing of packets for which each of the transfer devices 40 makes an inquiry about the processing. At this time, the notification generation unit 22 associates, with the corresponding transfer device 40 serving as a notification destination of the transfer rule, a destination address and a transmission source address of a flow for which the transfer rule is given notice of, thereby generates the flow information table 34.

In the example of FIG. 8, the transfer device 40a transfers packets, in which the address (IPb) assigned to the terminal of the user B is designated as transmission source address of the packets and “xx.yy.zz” is designated as destination addresses thereof. The transfer device 40b transfers packets addressed to the terminal (IPb) of the user B by a terminal to which the address of “xx.ww.z” is assigned. In the same way, the transfer device 40a transfers packets, in which the address (IPc) assigned to the terminal of the user C is transmission source addresses of the packets and “ghi.jkk” is designated as destination addresses thereof.

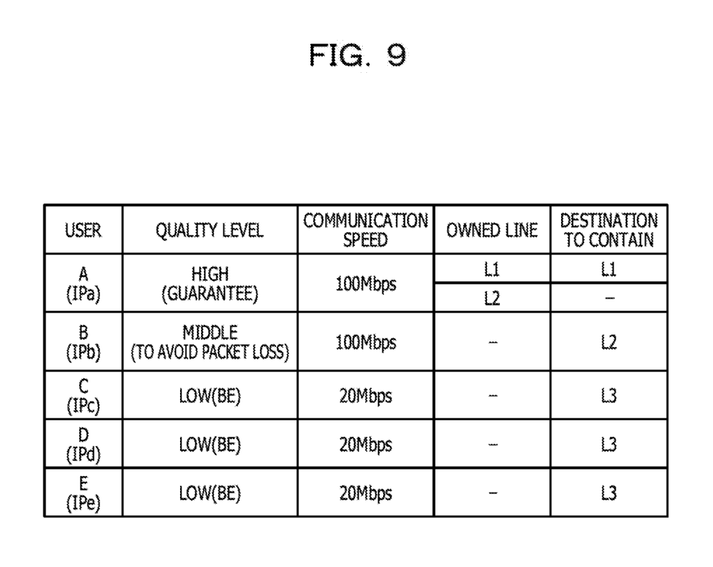

FIG. 9 is a diagram for explaining an example of the line information table 31. FIG. 9 is an example of the line information table 31 held by the control device 10 in a case where the communication illustrated in FIG. 6 is performed. For each of users, the line information table 31 includes user information, a quality level, a communication speed, an owned line, and information of a destination to contain. The user information is information for identifying a user. In the example of the line information table 31 illustrated in FIG. 9, identification information of the corresponding user is illustrated as the user information, and an IP address assigned to a terminal used by the corresponding user is described in parentheses. In FIG. 9, the quality level of the guarantee type, the quality level of the middle type, and the quality level of the best-effort type (BE type) are indicated by “High”, “Middle”, and “Low”, respectively. Since the user A makes the guarantee type contract, the quality level of the user A is “High”. In the same way, since the user B makes the middle type contract, the quality level of the user B is “Middle”. In addition, since the users C to E each make the best-effort type contract, the quality levels of the users C to E are “Low”. The communication speed of each of the user A and the user B is 100 Mbps, and the communication speed of each of the users C to E is 20 Mbps. In the fields of the owned line, identifiers of lines owned by individual users are recorded. Since the user A owns the lines L1 and L2, “L1” and “L2” are recorded in the field of the owned line. Since the users B to E each own no line, the fields of the owned line, associated with these users, are set to an invalid value.

The destination to contain is an identifier of a line that contains communication of each of users. Regarding the information of a user who owns lines, information of a destination to contain is recorded while being associated with one of the lines, which contains communication. The user A owns the lines L1 and L2, and the communication of the user A is contained in, for example, the line L1. Therefore, while being associated with the owned line L1, it is recorded in the line information table 31 that the destination to contain the communication of the user A is the line L1. On the other hand, while the user A owns the line L2, the communication of the user A is not contained in the line L2 at the point of time when the communication in FIG. 6 is performed. Therefore, in the field of the destination to contain, which is associated with the owned line L2 and which is included in the fields in which the information of the user A is recorded, the invalid value is set.

Regarding users who each own no line in such a manner as the users B to E, pieces of information of the destinations to contain are recorded in the line information table 31. In the example of FIG. 9, the communication of the user B is contained in the line L2, and the communication of the users C to E is contained in the line L3.

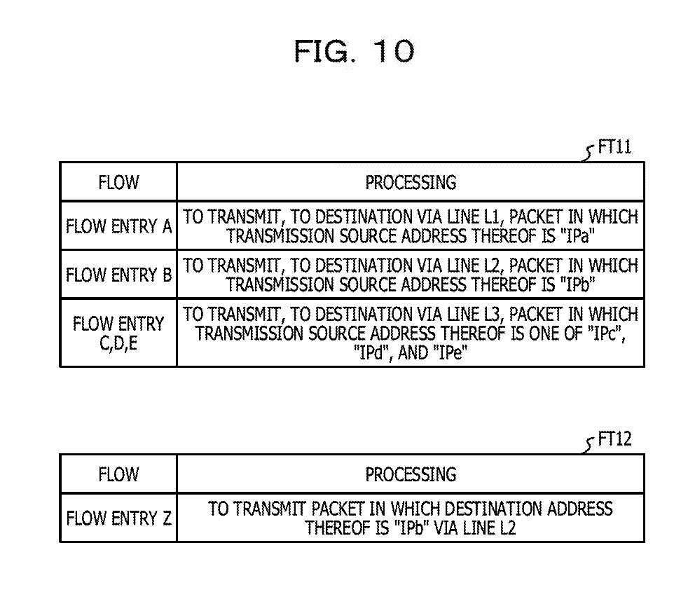

FIG. 10 is a diagram for explaining an example of a flow table. A flow table FT11 in FIG. 10 illustrates in detail a flow table held by the transfer device 40a in a case where the communication illustrated in FIG. 6 is performed. In the flow table, a flow entry to be used as information for identifying a flow and a content of processing for packets included in the relevant flow are associated with each other. The flow entry is arbitrary information capable of identifying the corresponding flow. The flow entry may be the number of an entry or may be a combination of pieces of information of an address and a port of the corresponding one of flows.

In the flow table FT11, as information of a flow entry A, it is described that a packet in which the transmission source address thereof is “IPa” is to be transmitted to a destination via the line L1. Here, “IPa” is an IP address assigned to the terminal used by the user A. Therefore, in accordance with the flow table FT11, the transfer device 40a transfers, to the destination via the line L1, a packet transmitted by the terminal of the user A. In the same way, as information of a flow entry B, it is described that a packet in which the transmission source address thereof is “IPb” is to be transmitted to a destination via the line L2. Here, “IPb” is an IP address assigned to the terminal of the user B. Therefore, the transfer device 40a transfers, to the destination via the line L2, a packet transmitted by the terminal of the user B. Furthermore, in the flow table FT11, as flow entries C to E, it is described that a packet in which the transmission source address thereof is one of “IPc”, “IPd”, and “IPe” is to be transmitted to a destination via the line L3. Here, “IPc” is an IP address assigned to the terminal of the user C, and “IPd” is an IP address assigned to the terminal of the user D. Furthermore, “IPe” is an IP address assigned to the terminal of the user E. Therefore, the transfer device 40a transfers, to the destination via the line L3, a packet transmitted by the terminal of one of the users C to E.

A flow table FT12 is an example of a flow table held by the transfer device 40b in a case where the communication illustrated in FIG. 6 is performed. In the flow table FT12, as a flow entry Z, it is described that a packet in which the destination address thereof is “IPb” is to be transmitted via the line L2. “IPb” is an IP address assigned to the terminal of the user B. Therefore, the transfer device 40b transfers, via the line L2, a packet transmitted so as to be addressed to the terminal of the user B.

(2) Communication at Time of Generation of Switching

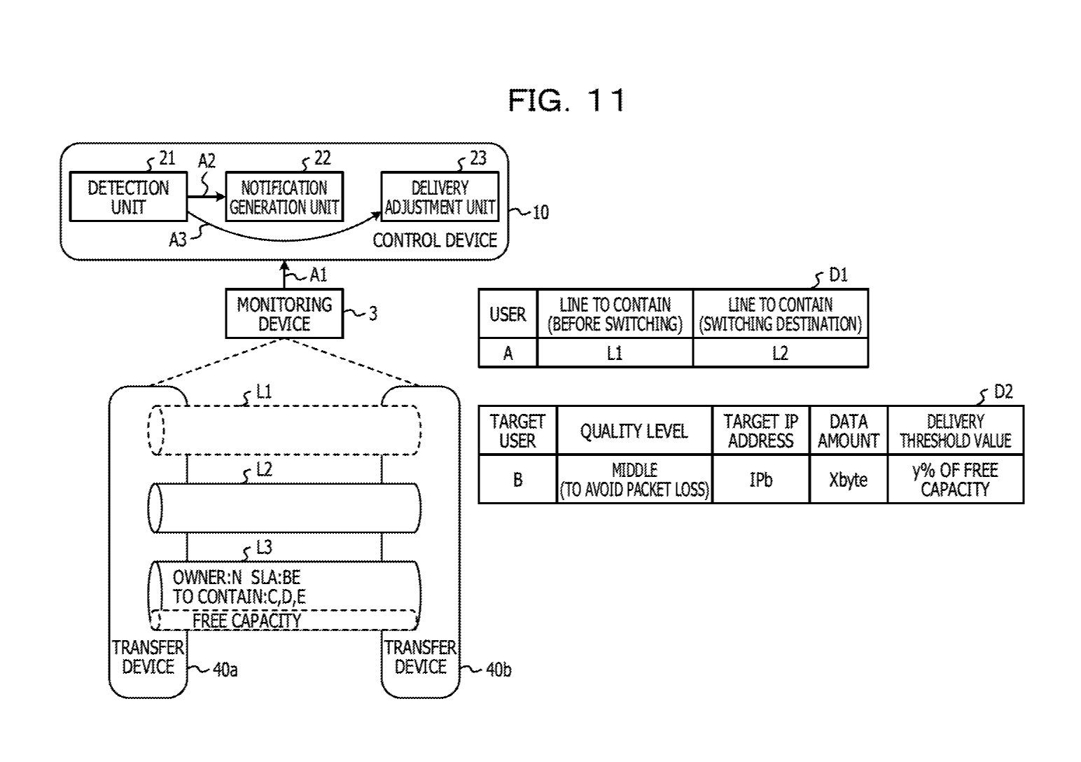

FIG. 11 is a diagram illustrating an example of a communication state at the time of the generation of switching. FIG. 11 illustrates an example of a case where the occurrence of a failure in the line L1 causes the line L1 to be unavailable for communication. The monitoring device 3 periodically monitors a state and so forth of a line used for communication between the transfer device 40a and the transfer device 40b. As monitoring processing performed by the monitoring device 3, an arbitrary known method may be used. Upon identifying that a failure occurs in the line L1, the monitoring device 3 references a preliminarily stored setting of the line, the information of whether the line is owned by a user, and so forth. The monitoring device 3 identifies that the line L1 contains the communication of the user A and that the line L2 is owned by the user A in addition to the line L1. Then, since the contract of the user A is the guarantee type, the monitoring device 3 determines that a line to contain the communication of the user A is to be switched from the line L1 to the line L2. The monitoring device 3 notifies the control device 10 of the generation of switching of a line (arrow A1).

Data D1 in FIG. 11 is an example of an information element of which the monitoring device 3 notifies the control device 10. As a user to serve as a switching target, the monitoring device 3 notifies the control device 10 of a user who made the guarantee type contract and who is included in users whose communication is contained in a line to become unavailable owing to the occurrence of a failure. Furthermore, the monitoring device 3 notifies the control device 10 of a line that contains communication of the corresponding user before switching and a line to contain the communication of the corresponding user after switching.

The detection unit 21 in the control device 10 acquires, via the reception unit 12, a packet received from the monitoring device 3. By using the acquired packet, the detection unit 21 detects that a line to contain the communication of the user A is to be changed from the line L1 to the line L2. By using the information of the data D1, the setting information table 33 (FIG. 7), and the line information table 31 (FIG. 9), the detection unit 21 determines whether there is a use whose line is to be switched owing to changing of a destination to contain the communication of the user A. In the case of FIG. 9, the communication speed of the user A is 100 Mbps, and the communication speed of the line L2 to serve as a new destination to contain the communication of the user A is 100 Mbps. Therefore, the detection unit 21 determines that switching of a line is to be performed for communication currently contained in the line L2. Here, the line L2 to serve as a destination to contain a line of the user A contains the communication of the user B. Therefore, the detection unit 21 determines that switching of a line for the user B is generated. Since the contract of the user B is the middle type, the detection unit 21 determines that processing for avoiding a packet loss is to be performed for packets to be used for the communication of the user B at the time of switching of a line.

First, the detection unit 21 searches for a line having a free capacity. In other words, the detection unit 21 searches for a line in which a maximum value of a communication speed obtained by the line is higher than a total value of communication speeds of communication contained in individual current lines. Based on the setting information table 33, the detection unit 21 determines that communication of up to 80 Mbps is available in the line L3. On the other hand, in the line information table 31, it is recorded that the communication speed of the communication of each of the users C to E contained in the line L3 is 20 Mbps. Therefore, the detection unit 21 calculates that communication of 60 Mbps is currently performed in the line L3. In the line L3, communication of up to 80 Mbps is available. However, since, at present, communication of 60 Mbps is performed, the detection unit 21 determines that the line L3 has a free capacity of 20 Mbps. In a case where there are lines that each has a free capacity, the detection unit 21 performs, in the same way, processing for each of the lines that each has a free capacity.

Next, the detection unit 21 compares the free capacity of a line likely to serve as a switching destination and the communication speed of a user to serve as a switching target. Here, while the free capacity of the line L3 is 20 Mbps, the communication speed of the current user B is 80 Mbps. There is no other line having a free capacity between the transfer device 40a and the transfer device 40b. Accordingly, the detection unit 21 determines that, at the time of changing a destination to contain the communication of the user B, a communication speed is reduced and a packet loss is likely to occur. Therefore, the detection unit 21 requests the notification generation unit 22 to cause packets used for the communication of the user B to be transferred by the corresponding transfer device 40 to the control device 10 (arrow A2).

In an arrow A3, the detection unit 21 requests the delivery adjustment unit 23 to buffer packets used for the communication of the user B and to transfer, to a transfer source, the buffered packets at a speed at which the packets are transferable by using a line after the switching. Data D2 is an example of an information element of which the detection unit 21 notifies the delivery adjustment unit 23. The data D2 includes a target user to serve as a target of buffering, a quality level of the target user, a target IP address, a data amount, and a delivery threshold value. The target IP address is an IP address assigned to a terminal used by the target user. The data amount is the amount of packets stored in the buffer 32 at the time of outputting the data D2. The delivery threshold value is used for determining whether the amount of packets stored in the buffer 32 as packets used for communication of the target user reaches an amount to be delivered to the corresponding transfer device 40 that has transferred the packets. The delivery threshold value may be a specific value indicating a data amount or may be a ratio to the free capacity of a line set as a switching destination. In the example of FIG. 11, the delivery threshold value is expressed by a ratio to a free capacity. If the delivery threshold value is expressed by a ratio to a free capacity, in a case where a line used for switching is set, the delivery adjustment unit 23 determines the delivery threshold value in accordance with the free capacity of a line serving as a switching destination.

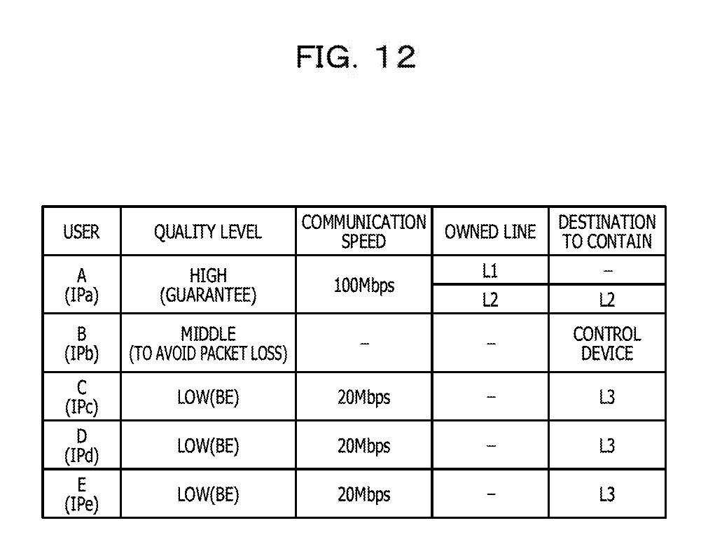

FIG. 12 is a diagram for explaining an example of the line information table 31. FIG. 12 is an example of the line information table 31 in a case where the detection unit 21 determines that packets used for communication of a user for which a packet loss is avoided are to be transferred by the corresponding transfer device 40 to the control device 10. In the line information table 31 illustrated in FIG. 12, the information of the users C to E is the same as that before the generation of switching of a line, described with reference to FIG. 9. Since a failure occurs in the line L1 out of owned lines of the user A, the communication of the user A is contained in the line L2. Since the communication speeds of both the line L1 and the line L2 are equal to each other, the communication of the user A is not changed. Therefore, the information of the user A is the same as the information at the time of FIG. 9 except that a line serving as a destination to contain is changed to the line L2.

On the other hand, while the communication of the user B turns out not to be contained in the line L2, the detection unit 21 does not find a destination to contain, which is able to contain without change in a communication speed. Therefore, the control device 10 performs buffering and so forth, thereby controlling a communication speed. Therefore, in the line information table 31 illustrated in FIG. 12, a destination to contain the communication of the user B is set to the control device 10.

After that, from among lines having free capacities, the detection unit 21 determines a line to contain communication in which the control device 10 transfers while buffering. In the line information table 31, the detection unit 21 records the information of the determined line, as the line to contain communication serving as a switching target.

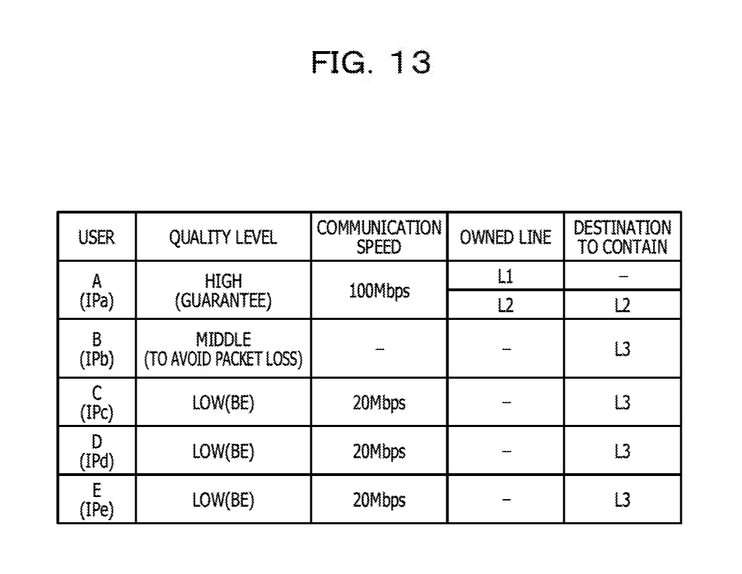

FIG. 13 is a diagram for explaining an example of the line information table 31. In the line information table 31 illustrated in FIG. 13, it is recorded that the communication of the user B is to be contained in the line L3. As described with reference to FIG. 11, in a case where there is only one line having a free capacity, the detection unit 21 may update the line information table 31 in FIG. 9 as illustrated in FIG. 13 without updating to the line information table 31 illustrated in FIG. 12.

As illustrated by the arrow A2 in FIG. 11, upon being notified that packets used for the communication of the user B are to be transferred to the control device 10, the notification generation unit 22 searches the flow information table 34 (FIG. 8) by using the IP address (IPb) assigned to the terminal of the user B as a key. The notification generation unit 22 identifies that transfer processing of packets in which “IPb” is set as the transmission source address thereof is performed by the transfer device 40a and that transfer processing of packets in which “IPb” is set as the destination address thereof is performed by the transfer device 40b. The notification generation unit 22 generates a request message that is addressed to the transfer device 40a and that is used for requesting to transfer, to the control device 10, packets in which “IPb” is set as the transmission source address thereof. The request message is transmitted to the transfer device 40a by the transmission unit 11. At this time, the request message transmitted to the transfer device 40a by the control device 10 includes information for specifying that packets transmitted from the address (IPa) assigned to the terminal of the user A are to be transferred via the line L2. As the request message, for example, a FlowMod message of Openflow is used.

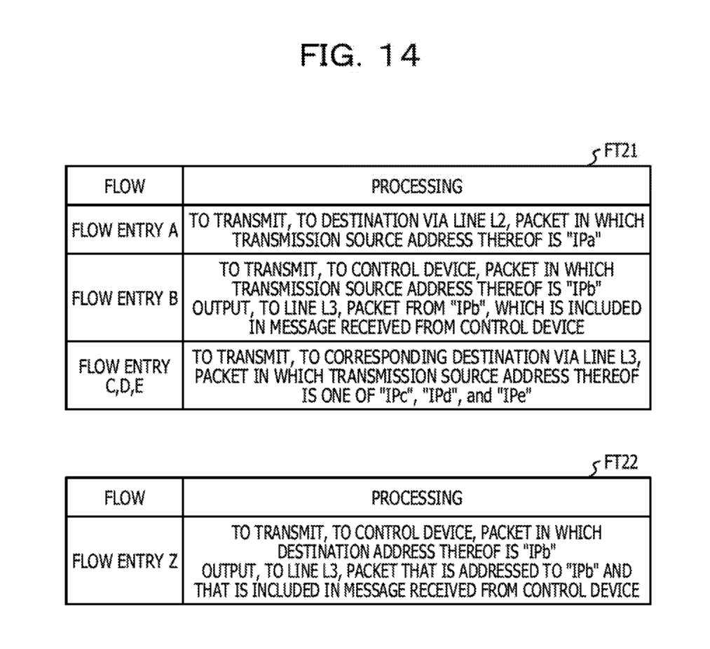

FIG. 14 is a diagram for explaining an example of a flow table. Upon receiving the request message from the control device 10, the transfer device 40a processes the request message, thereby updating the flow table FT11 (FIG. 10) to a flow table FT21. In the flow table FT21, as the information of the flow entry A, it is described that a packet in which the transmission source address thereof is set to the IP address (IPa) of the terminal used by the user A is to be transmitted to a destination via the line L2. As the information of the flow entry B, in the flow table FT21, it is recorded that a reception packet in which the transmission source address thereof is “IPb” is to be transferred to the control device 10. Furthermore, in the updated flow table FT21, it is described that a packet that is included in a message received from the control device 10 and in which the transmission source address thereof is set to “IPb” is transmitted via the line L3. “IPb” is the IP address assigned to the terminal of the user B. Therefore, after updating to the flow table FT21, the transfer device 40a transfers, to the control device 10, a packet transmitted by the terminal of the user B. Furthermore, the transfer device 40a transmits, via the line L3, a packet that is included in a control message such as Packet-Out, received from the control device 10, and in which the transmission source thereof is set to “IPb”. In the same way, after updating to the flow table FT21, the transfer device 40a transfers, to a destination via the line L2, a packet transmitted by the terminal of the user A.

The notification generation unit 22 transmits a request message to the transfer device 40b via the transmission unit 11. In this case, a request message that requests to transfer, to the control device 10, packets in which the destination address thereof is set to “IPb” is transmitted to the transfer device 40b. The transfer device 40b processes the request message received from the control device 10, thereby recording it in a flow table that a packet addressed to “IPb” is to be transferred to the control device 10.

A flow table FT22 in FIG. 14 is a flow table updated by the transfer device 40b. In the transfer device 40b, based on processing of the request message from the control device 10, the flow table FT12 (FIG. 10) is updated to the flow table FT22. As the information of the flow entry Z, it is recorded in the flow table FT22 that a reception packet in which the destination address thereof is “IPb” is to be transferred to the control device 10. Furthermore, it is described in the flow table FT22 that a packet, included in a message received from the control device 10 and addressed to “IPb”, is to be transmitted via the line L3. Therefore, after updating to the flow table FT22, the transfer device 40b transfers, to the control device 10, a packet addressed to the terminal of the user B. Furthermore, the transfer device 40b transmits, via the line L3, a packet that is included in a control message such as Packet-Out, received from the control device 10, and that is addressed to “IPb”.

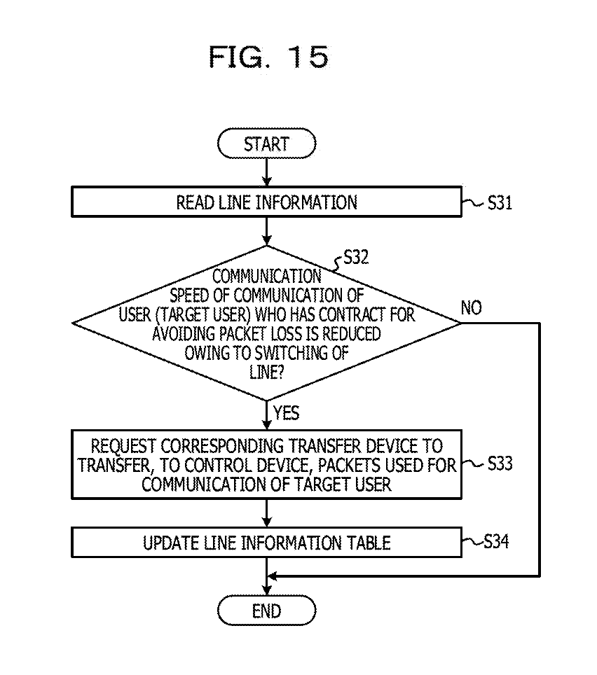

FIG. 15 is a flowchart for explaining an example of processing for switching a line. FIG. 15 is processing performed by the control device 10 in a case of being notified of the generation of switching of a line by the monitoring device 3. The processing in FIG. 15 is an example, and the order of, for example, S33 and S34 may be arbitrarily changed.

By using the line information table 31, the detection unit 21 reads line information within a network (S31). For communication of a user (target user) who has a contract for avoiding a packet loss, the detection unit 21 determines whether switching of a line causes a communication speed to be reduced (S32). In a case where a line used for communication of the target user is not switched or in a case where switching of a line does not cause the communication speed of the target user to be reduced, the detection unit 21 terminates the processing (S32: No). In a case where switching of a line used for the communication of the target user causes a communication speed to be reduced, the detection unit 21 informs the notification generation unit 22 to that effect (S32: Yes). By transmitting a request packet via the transmission unit 11, the notification generation unit 22 requests the corresponding transfer device 40 to transfer, to the control device 10, packets used for the communication of the target user (S33). After that, the detection unit 21 updates the line information table 31 (S34).

(3) Communication after Switching of Line

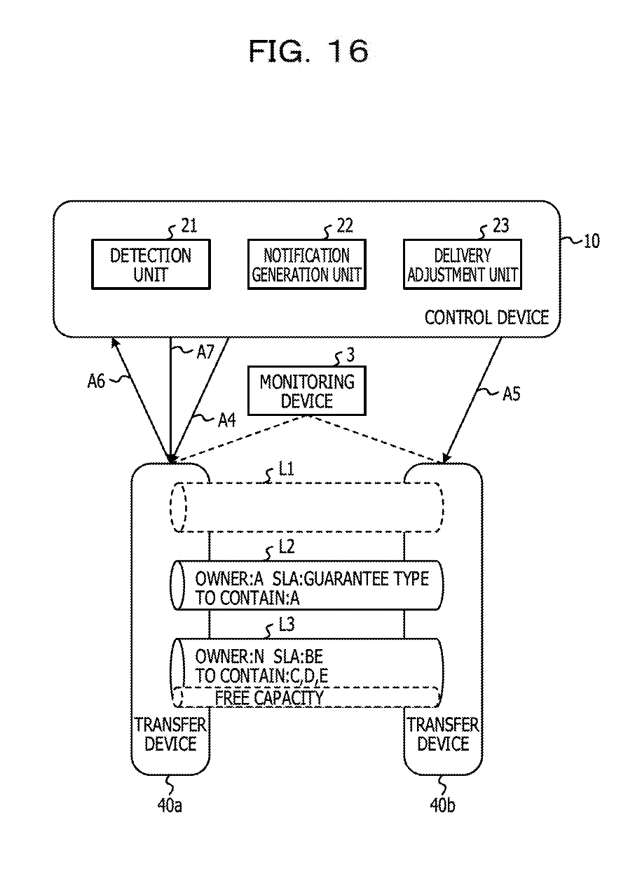

FIG. 16 is a diagram illustrating an example of communication after a line to serve as a switching destination is determined. An arrow A4 indicates transmission of a request message from the control device 10 to the transfer device 40a. An arrow AS indicates transmission of a request message from the control device 10 to the transfer device 40b. When the processing operations in the arrows A4 and AS finish, the line information table 31 is as illustrated in FIG. 13, and the flow table held by each of the transfer devices 40 is as illustrated in FIG. 14.

Upon receiving packets transmitted by the terminal of the user B, since the transmission source address of the packets is “IPb”, the transfer device 40a transfers the reception packets to the control device 10 in accordance with the flow table FT21 (arrow A6). In the example of FIG. 16, a Packet-In message of Openflow is used for processing for transferring packets from the corresponding transfer device 40 to the control device 10.

The reception unit 12 in the control device 10 outputs the Packet-In message to the delivery adjustment unit 23. The delivery adjustment unit 23 stores, in the buffer 32, packets that serve as transfer targets and that are included in the Packet-In message transferred by the corresponding transfer device 40. In the same way, in a case where the transfer device 40b transfers, to the control device 10, packets addressed to “IPb”, the delivery adjustment unit 23 stores, in the buffer 32, packets included in the Packet-In message received from the transfer device 40b.

By using the amount of packets periodically stored in the buffer 32 and the delivery threshold value, the delivery adjustment unit 23 determines whether to transfer packets to the corresponding transfer device 40 serving as a transfer source. In a case where the delivery adjustment unit 23 is notified of the data D2 in FIG. 11, the delivery threshold value is y % of an amount to be transferred at a predetermined time by using the free capacity of the line L3. Therefore, if the amount of packets that are used for the communication of the user B and that are stored in the buffer 32 reaches the delivery threshold value, the delivery adjustment unit 23 transfers, to the corresponding transfer device 40 serving as a transfer source of the packets, packets that are surplus to the delivery threshold value and that are included in the buffered packet. A Packet-Out message is used for processing for transferring packets from the control device 10 to the corresponding transfer device 40. In addition to packets serving as transfer targets, the Packet-Out message may include a transfer rule used for transfer processing of the packets serving as transfer targets. An arrow A7 indicates the control device 10 transmitting the Packet-Out message to the transfer device 40a.

Upon receiving the Packet-Out message through the arrow A7, the transfer device 40a extracts, as transfer targets, packets included in the Packet-Out message. Here, the transmission source address of packets extracted from the Packet-Out message is “IPb”. Therefore, in accordance with the flow table FT21 (FIG. 14), the transfer device 40a transmits, via the line L3, packets extracted from the Packet-Out message. The Packet-Out message transmitted to the transfer device 40b by the control device 10 is processed in the same way as processing in the transfer device 40a. Therefore, in the system according to an embodiment, while the line L3 contains the communication of the user B, packets are arbitrarily buffered by the control device 10 in association with the reduction of a communication speed. Therefore, even if a line to contain the communication of the user B is switched, no packet loss occurs.

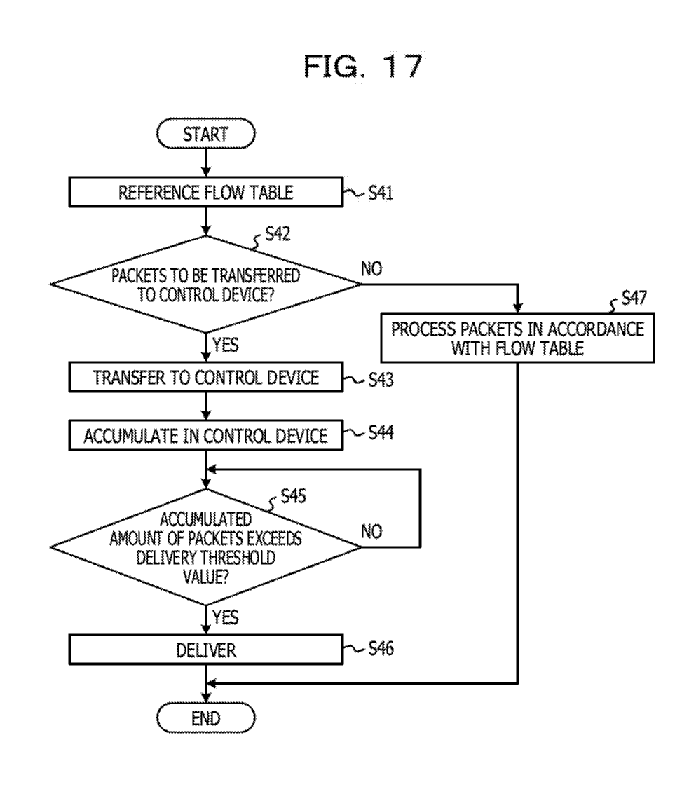

FIG. 17 a flowchart for explaining an example of processing of packets after a line is switched. Upon receiving packets, the corresponding transfer device 40 references a flow table, thereby identifying processing of the received packets (S41). The corresponding transfer device 40 determines whether the received packets are packets to be transferred to the control device 10 (S42). In a case where the received packets are packets to be transferred to the control device 10, the corresponding transfer device 40 transfers the packets to the control device 10 (S42: Yes, S43). The control device 10 accumulates, in the buffer 32, packets transferred by the corresponding transfer device 40 (S44). The delivery adjustment unit 23 determines whether the accumulated amount of packets exceeds the delivery threshold value (S45). In a case where the accumulated amount of packets exceeds the delivery threshold value, the corresponding transfer device 40 transmits packets surplus to the delivery threshold value, to the corresponding transfer device 40 serving as a transfer source of the packets (S45: Yes, S46). On the other hand, in a case where the received packets are not packets to be transferred to the control device 10, the corresponding transfer device 40 processes the packets in accordance with the flow table (S42: No, S47).

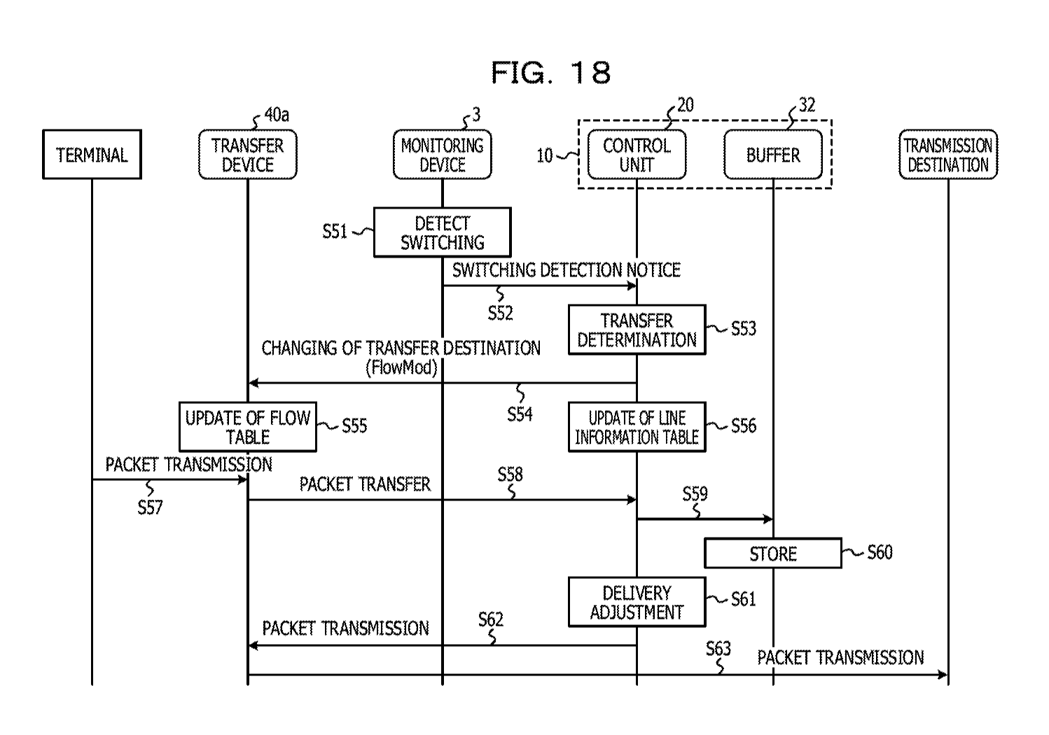

FIG. 18 is a sequence diagram for explaining an example of communication processing. Processing performed between detection of switching of a line and transmission of packets based on a line after the switching will be described over time with reference to FIG. 18.

Upon detecting switching of a path, the monitoring device 3 transmits, to the control device 10, a switching detection notice for giving notice of the generation of switching of a path (S51, S52). The detection unit 21 determines whether to request the corresponding transfer device 40 to transfer, to the control device 10, packets used for communication by a user (target user) who has a contract for avoiding a packet loss (S53). In S53, it is determined whether switching of a line causes the communication speed of the terminal of the target user to be reduced. In a case where the switching of a line causes the communication speed of the terminal of the target user to be reduced, the notification generation unit 22 generates a FlowMod message for requesting the corresponding transfer device 40 to change a transfer destination and transmits the FlowMod message to the corresponding transfer device 40 via the transmission unit 11 (S54). The FlowMod message transmitted in S54 is a message for requesting the transfer device 40a to change, to the control device 10, the transfer destination of packets used for the communication of the target user. In the example of FIG. 18, in the FlowMod message transmitted in S54, output destinations of packets that are included in the control message received from the control device 10 and that are included in the packets used for the communication of the target user are given notice of together. By using the FlowMod message, the transfer device 40a updates a flow table (S55). On the other hand, the detection unit 21 updates the line information table 31 (S56).

After that, packets addressed to transmission destinations are transmitted by the terminal of the target user (S57). In accordance with a flow table after update, the transfer device 40a transfers reception packets to the control device 10 (S58). The delivery adjustment unit 23 outputs, to the buffer 32, the packets transferred by the transfer device 40a (S59). The buffer 32 stores therein input packets (S60).

By performing delivery adjustment processing by use of the delivery threshold value, the delivery adjustment unit 23 transmits, to the transfer device 40a, some of the packets transmitted by the terminal of the target user, at a speed slower than the communication speed of a line after switching (S61, S62). In accordance with a flow table, by using a line after switching, the transfer device 40a transmits, to destinations, the packets received from the control device 10 (S63).

In this way, in a case where a line used for the communication of the target user who has a contract for avoiding a packet loss is switched, thereby causing a communication speed to be reduced, the control device 10 changes transfer processing in the corresponding transfer device 40. The control device 10 buffers packets used for the communication of the target user and transfers, via the corresponding transfer device 40 serving as a transfer source of the packets, packets of the target user at a speed lower than a communication speed obtained by a path after switching. Therefore, a packet loss is avoided.

### Example of Modification

An embodiment is not limited to the above-mentioned embodiment and may be variously modified. Some of examples thereof will be described below.

For example, a recovery from a failure after execution of processing for switching of a line may cause the line to be switched to a state before switching of the line again. It is assumed that, in, for example, the network described by using FIG. 6 to FIG. 17, the line L1 is restored after a line to contain the communication of the user B is switched to the line L3.

Then, the monitoring device 3 notifies the control device 10 that the line L1 is restored and that a destination to contain the communication of the user A is to be changed from the line L2 to the line L1. By using the line information table 31 and the setting information table 33, the detection unit 21 in the control device 10 detects that it is possible to switch a destination to contain the communication of the user B from the line L3 to the line L2. Since the communication speed of the user B is less than or equal to a communication speed obtained by using the line L2, the detection unit 21 determines that it is possible to perform communication not via the control device 10 but via the line L2. Then, the detection unit 21 requests the notification generation unit 22 to perform processing for stopping transferring, to the control device 10, packets used for the communication of the user B.

By using the flow information table 34, the notification generation unit 22 generates a request message for requesting to output, to the line L2, packets used for the communication of the user B while addressing the request message to each of the transfer device 40a and the transfer device 40b. The request message is transmitted via the transmission unit 11. By processing the request message, each of the transfer device 40a and the transfer device 40b changes a flow table. Therefore, the flow table is changed as illustrated in FIG. 10, and processing before switching of a line is started. Therefore, as illustrated in FIG. 6, the communication of the user A is contained in the line L1, the communication of the user B is contained in the line L2, and the communication of the users C to E is contained in the line L3.

The tables used in the above-mentioned description and information elements included in transmitted or received data may be changed in accordance with implementation. The delivery threshold value is set for each of used lines, and a setting method is arbitrary. The delivery threshold value may be determined by, for example, an owner of a line.

Timing when the control device 10 notifies the corresponding transfer device 40 of an output destination of packets after switching of a line may be changed in accordance with implementation. An output destination of packets after switching of a line is used as an output destination of packets output to the corresponding transfer device 40 by the control device 10 by using Packet-Out or the like. Processing of packets transferred to the corresponding transfer device 40 by the control device 10 may be included in, for example, Packet-Out. Each of the transfer devices 40 may be notified of a request to transfer packets to the control device 10 and an output destination of packets after switching of a line by using respective different FlowMod messages. Furthermore, in a case where, as described with reference to FIG. 11, a line to serve as a switching destination is uniquely determined, the control device 10 may notify the corresponding transfer device 40 of information of the switching destination while causing the information of the switching destination to be included in a request message for requesting to transfer packets to the control device 10.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control method executed by a processor included in a control device coupled to a first transfer device and a second transfer device, the first transfer device being coupled to the second transfer device via a plurality of lines, the control method comprising:
detecting a notification to inform that switching of a line used for transferring packets by the first transfer device and the second transfer device, among the plurality of lines, is to be occurred;
transmitting, to the first transfer device and the second transfer device, an instruction for requesting to transfer the packets to the control device;
storing the packets received from the first transfer device and the second transfer device;
transmitting, to the first transfer device and the second transfer device, a transfer rule for designating a line after the switching, among the plurality of lines, as an output destination of the packets to be transferred by the control device, when the switching occurred;
reading the stored packets; and
transmitting the read packets to the first transfer device and the second transfer device at a speed at which the read packets are transferable by using the line after the switching.

2. The control method according to claim 1, further comprising:
determining whether a user related to communication in which a communication speed is reduced owing to the switching exists among a plurality of users who use the plurality of lines,
wherein the transmitting the instruction includes transmitting, to the first transfer device and the second transfer device, the instruction for requesting to transfer the packets transmitted by the user to the first transfer device and the second transfer device, when it is determined that the user exists.

3. The control method according to claim 2,
wherein the determining includes determining whether the user for which a communication speed is reduced exists, by using a result of comparing, for each of the users, a current communication speed and a prediction value of a communication speed to be obtained after the switching with each other.

4. The control method according to claim 1,
wherein the detecting includes receiving a notice for notifying that a first line used for transfer of packets transmitted by a first communication device that communicates with a communication destination via the transfer device is to be used for communication of a second communication device having priority higher than that of communication of the first communication device.

5. The control method according to claim 4, further comprising:
identifying a second line to be used for the communication of the first communication device; and
determining whether a communication speed of the first communication device is reduced owing to the switching, by comparing a communication speed of the first communication device obtained in a case of using the second line, and a communication speed of the first communication device obtained in a case of using the first line, with each other,
wherein the transferring includes
transferring, to the transfer device, a packet transmitted by the first communication device at a speed less than or equal to a communication speed of the first communication device after the switching, when it is determined that the communication speed of the first communication device is reduced owing to the switching.

6. A control device coupled to a transfer device, the transfer device being coupled to another transfer device via a plurality of lines, the control device comprising:
a memory; and
a processor coupled to the memory and configured to:
detect a notification to inform that switching of a line used for transferring packets by the first transfer device and the second transfer device, among the plurality of lines, is to be occurred;
transmit, to the first transfer device and the second transfer device, an instruction for requesting to transfer the packets to the control device;
store the packets received from the first transfer device and the second transfer device;
transmit, to the first transfer device and the second transfer device, a transfer rule for designating a line after the switching, among the plurality of lines, as an output destination of the packets to be transferred by the control device, when the switching occurred;
read the stored packets; and
transmit the read packets to the first transfer device and the second transfer device at a speed at which the read packets are transferable by using the line after the switching.

7. The control device according to claim 6, wherein the processor is configured to:
determine whether a user related to communication in which a communication speed is reduced owing to the switching exists among a plurality of users who use the plurality of lines, and
transmit, to the first transfer device and the second transfer device, the instruction for requesting to transfer the packets transmitted by the user to the first transfer device and the second transfer device, when it is determined that the user exists.

8. The control device according to claim 7, wherein the processor is configured to
determine whether the user for which a communication speed is reduced exists, by using a result of comparing, for each of the users, a current communication speed and a prediction value of a communication speed to be obtained after the switching with each other.

9. A non-transitory computer-readable storage medium storing a program that causes a processor included in a control device coupled to a transfer device to execute a process, the transfer device being coupled to another transfer device via a plurality of lines, the process comprising:
detecting a notification to inform that switching of a line used for transferring packets by the first transfer device and the second transfer device, among the plurality of lines, is to be occurred;
transmitting, to the first transfer device and the second transfer device, an instruction for requesting to transfer the packets to the control device;
storing the packets received from the first transfer device and the second transfer device;
transmitting, to the first transfer device and the second transfer device, a transfer rule for designating a line after the switching, among the plurality of lines, as an output destination of the packets to be transferred by the control device, when the switching occurred;
reading the stored packets; and
transmitting the read packets to the first transfer device and the second transfer device at a speed at which the read packets are transferable by using the line after the switching.

10. The storage medium according to claim 9, wherein the process further comprising:
determining whether a user related to communication in which a communication speed is reduced owing to the switching exists among a plurality of users who use the plurality of lines,
wherein the transmitting the instruction includes transmitting, to the first transfer device and the second transfer device, the instruction for requesting to transfer the packets transmitted by the user to the first transfer device and the second transfer device, when it is determined that the user exists.
